(19) United States
(12) Patent Application Publication
(10) Pub. No.: US 2007/0144849 A1
(43) Pub. Date: Jun. 28, 2007

(54) Connecting bearing for a vibration damper

(75) Inventors: Wolfgang Breun, Niederwerrn (DE); Andreas Zietsch, Uchtelhausen-Zell (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/640,554

(22) Filed: Dec. 18, 2006

(30) Foreign Application Priority Data
Dec. 19, 2005 (DE) 10 2005 061 011.0

(51) Int. Cl. F16F 9/00

(52) U.S. Cl. 188/321.11

(57) ABSTRACT

A connecting bearing for a vibration damper includes a cup-shaped bearing housing, in which a disk-shaped transmission element with parallel top and bottom surfaces is provided, this element being attached to the vibration damper. Elastomeric bodies are arranged above and below the top and bottom surfaces, respectively, and a compensating element is provided to compensate for an angular offset between the vibration damper and a line perpendicular to a connecting surface of the connecting bearing. The compensating element is located between at least one of the elastomeric bodies and the transmission element.

### BACKGROUND OF THE INVENTION

1. Field of the Invention

The invention relates to a connecting bearing for a vibration damper with a cup-shaped bearing housing, a disk-shaped transmission element, and elastomeric bodies on opposing sides of the transmission element.

2. Description of the Related Art

A connecting bearing for a vibration damper is known from DE 198 03 174 A1. The connecting bearing comprises a cup-shaped bearing housing, in which a transmission element, which is connected to a piston rod of the vibration damper, is equipped with elastomeric bodies at the top and bottom. Many variants of this design are known.

Especially for reasons of space availability, vibration dampers without vehicle suspension springs are also being installed increasingly at an angle to the vehicle axis. U.S. Patent Application Publication No. 2005/0155829 can be cited as an example. The basic design is similar to that of DE 198 03 174. To compensate for the slanted position, a two-part cap with a wedge-shaped cross section is used. The structural design of the cap appears complicated, and because of the use of plastic as basic material, the spring characteristic of the connecting bearing can be softer in the area of the cap where the material is thicker than it is at the edge, where the material is thinner. For functional reasons, a relative soft plastic would have to be selected, because a circumferential seal, which must have a significant degree of elasticity, is provided at the outer edge of the cap.

As a replacement, it would be possible to use a wedge-shaped elastomeric body at the top, but then it would again be necessary to tolerate differences in the spring characteristic.

### SUMMARY OF THE INVENTION

An object of the present invention is to provide a connecting bearing of a vibration damper installed at an angle that overcomes the problems of the prior art.

According to the present invention, the object is met by a connecting bearing connecting bearing for a vibration damper with a cup-shaped bearing housing, a disk-shaped transmission element, and elastomeric bodies on opposing sides of the transmission element, wherein a compensating element is located between at least one of the elastomeric bodies and the transmission element.

An advantage of this embodiment is that there is no need for a cap as a compensating element and a standardized transmission element can be used for both right-angled and slanted connecting bearings.

In a further embodiment, the top of the elastomeric body has a sealing lip. This eliminates the need for a separate sealing element.

According to another embodiment, the compensating element is firmly bonded to the transmission element such as, for example, by melt-welding or press-welding. The transmission element may be coated or molded over with an inelastic plastic such as polyamide;

To provide secure axial positioning, the compensating element at least partially covers the transmission element at the top and bottom, these two areas of the transmission element being connected to each other.

The top and bottom surfaces of the transmission element and an edge surface are coated with a plastic, which serves as the compensating element. The plastic coating extends over the outer lateral surface of the transmission element, so that a simple disk in the form of a circular ring can be used as a transmission element, which does not have to have an additional through-opening.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is to be explained in greater detail of the following description of the figures, in which:

FIG. 1 is a partial sectional side view of a connecting bearing with a vibration damper; and

FIG. 2 is an enlarged sectional view of the connecting bearing.

### DETAILED DESCRIPTION OF THE PRESENTLY PREFERRED EMBODIMENTS

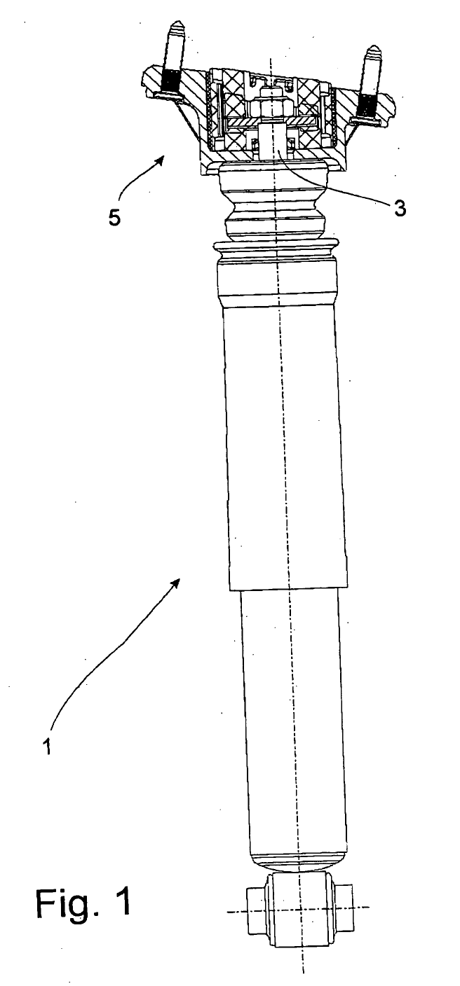

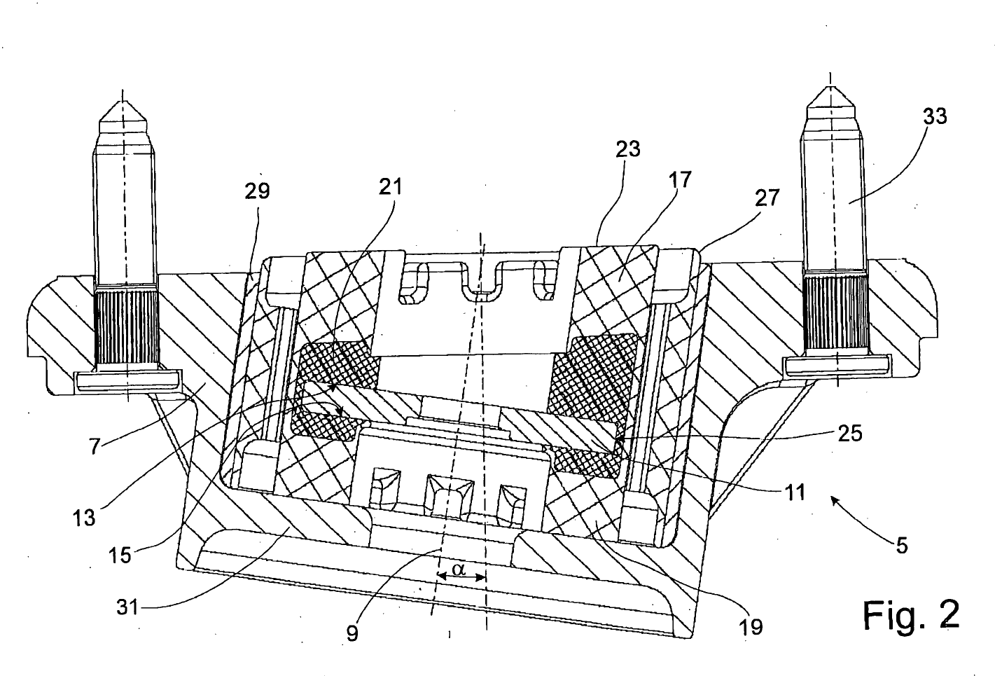

FIG. 1 shows a vibration damper 1 of any design having a piston rod 3 to which a connecting bearing 5 is attached. As shown in the enlarged view according to FIG. 2, the connection bearing includes a cup-shaped housing 7 which serves as the load-bearing component of the connecting bearing 5 and has a main axis 9. A transmission element 11 for the piston rod 5 of the vibration damper is located inside the housing 7. The transmission element 11 is in the form of a circular ring having opposing parallel surfaces 13, 15. Elastomeric bodies 17, 19 are arranged over and below the parallel surfaces 13, 15, respectively. Each of the elastomeric bodies 17, 19 have a constant spring cross section.

A compensating element 21 with a wedge-shaped cross section is located between the elastomeric body 17 and the top surface 13 to compensate for the angular offset a between a line perpendicular to a connecting surface 23 of the connecting bearing 5 and a main axis 9 of the connecting bearing.

The compensating element 21 consists of plastic, e.g., polyamide, and is firmly bonded to the transmission element 11. The bottom surface 15 of the transmission element is also at least partially covered by the compensating element 21. The outside edge of the compensating element 21, furthermore, also extends across the outer lateral surface 25 of the transmission element 11, so that a positive connection is present between the transmission element and the compensating element in both the axial and radial directions.

The top surface 17 of the elastomeric body is provided with a sealing lip 27, which, in the final, assembled state of the connecting bearing 5, comes to rest against a surface of a cap on the vehicle body side and thus prevents the intrusion of moisture into the connecting bearing. A straining ring 29 radially supports the outer lateral surface of the elastomeric body 17. After the overall structural unit including transmission element 11, elastomeric body 17, compensating element 21, and straining ring 29 has been properly oriented in the circumferential direction, it is inserted into the housing 7 until it rests on the bottom 31 of the housing. Straining screws 33 hold the connecting bearing in position on the vehicle body.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A connecting bearing for a vibration damper, comprising:
a cup-shaped bearing housing for receiving the vibration damper along a longitudinal axis;
a disk-shaped transmission element with parallel top and bottom surfaces arranged in said housing, the transmission element being attachable to the vibration damper;
elastomeric bodies at the top and bottom of the transmission element; and
a compensating element located between at least one of said elastomeric bodies and said transmission element, said compensating element being arranged and dimensioned to compensate for an angular offset between the longitudinal axis of the housing and a line perpendicular to a connecting surface of said connecting bearing, wherein the compensating element is configured so that each of the elastomeric bodies has a constant spring cross-section with respect to radial cross-sections about said longitudinal axis.

2. The connecting bearing of claim 1, wherein a sealing lip is formed on a top surface of one of said elastomeric bodies.

3. The connecting bearing of claim 1, wherein said compensating element is firmly bonded to said transmission element.

4. The connecting bearing of claim 1, wherein said compensating element includes a first area at least partially covers said top surface of said transmission element and a second area at least partially covering said bottom surface of said transmission element, the two areas of said compensating element being connected to each other.

5. The connecting bearing of claim 4, wherein said top and bottom surfaces of said transmission element are coated with a plastic forming said compensating element.

6. The connecting bearing of claim 5, wherein said compensating element extends across an outer lateral surface of said transmission element.
